(19) United States
(12) Patent Application Publication
(10) Pub. No.: US 2022/0232813 A1
(43) Pub. Date: Jul. 28, 2022

(54) Insect Trap and Classification System

(71) Applicant: PestNotify Patent Holdco, LLC, Loveland, CO (US)

(72) Inventor: Robert F Edwards, JR., Butte, MT (US)

(21) Appl. No.: 17/156,569

(22) Filed: Jan. 23, 2021

(51) Int. Cl. A01M 1/02; A01M 1/10

(52) U.S. Cl. CPC A01M 1/026; A01M 1/103

(57) ABSTRACT

A monitoring trap and classification system may help pest control professionals, landlords, and homeowners identify, monitor, and manage insects. The trap may have an adhesive area that traps an insect, as well as several features that assist in identifying the insect. A classification system may use a picture or image of the trap to extract the trap's identifier, orient and adjust the image to standardize the image's color and scale, and have the insect identified. The trap and classification system may be used by individual homeowners, tenants, landlords, farmers, and pest professionals to capture, identify, and manage insects. The classification system may reduce the complexity of counting and classifying trapped insects, and it may generate a history through a series of reminders and keeping a database of previous observations.

### BACKGROUND

Insects have long been a problem in structures. From bed bugs to ticks, from houseflies to spiders, insects are often known as “pests.” These pests can range from mere inconveniences to spreaders of disease. Each region of the country is plagued by its own set of pests, and the pest control industry exists for managing these insects in homes, businesses, restaurants, industrial factories, schools, greenhouses, and other buildings. Additionally, insects play important roles in the agriculture economy, where harmful insects may consume or damage crops, while helpful insects may combat the harmful insects or provide pollination or other functions that aid the crops.

### SUMMARY

A monitoring trap and classification system may help pest control professionals, landlords, and homeowners identify, monitor, and manage insects. The trap may have an adhesive area that traps an insect, as well as several features that assist in identifying the insect. A classification system may use a picture or image of the trap to extract the trap's identifier, orient and adjust the image to standardize the image's color and scale, and have the insect identified. The trap and classification system may be used by individual homeowners, tenants, landlords, farmers, and pest professionals to capture, identify, and manage insects. The classification system may reduce the complexity of counting and classifying trapped insects, and it may generate a history through a series of reminders and keeping a database of previous observations.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an example embodiment showing a monitoring trap and a service for classifying and managing images of the trap.

FIG. 2 is a diagram illustration of an example embodiment showing a monitoring trap.

FIG. 3 is a diagram illustration of an example embodiment showing a cross-section of a monitoring trap.

FIG. 4 is a diagram illustration of an embodiment showing a network environment showing a monitoring and analysis system for traps.

FIGS. 5A and 5B are flowchart illustrations of an embodiment showing a method for deploying and managing monitoring traps.

FIG. 6 is a flowchart illustration of an embodiment showing a method for pre-processing an image prior to analysis.

FIG. 7 is a diagram illustration of an example embodiment showing a user interface showing an apartment map for managing pests.

FIG. 8 is a flowchart illustration of an embodiment showing a method for updating the frequency of monitoring based on an outbreak.

### DETAILED DESCRIPTION

Monitoring Trap

An insect monitoring trap may consist of a base with an adhesive that may trap insects that attempt to traverse the adhesive. The base may have an identifier and other features that may be captured by a cell phone or other device used to take a picture of the trap. The picture may be sent to a classification system where any insects on the trap may be identified and counted, then records of the observations may be stored and may be available to the users.

The trap may include identification, which may be a machine-readable identification such as a one-dimensional or two-dimensional barcode. In many cases, the identification may include human readable text identifiers. The identification may be unique to each trap, such that a record of each trap may be created and tracked over time.

The trap may be used for longer term monitoring of insects in a location. As a monitoring trap, images may be taken over a period of time to identify changes in the insect population of the area. A typical cadence for monitoring a residential location may be to take an image every month, for example. Images of the trap from month to month may be used to identify and count any change in the presence of insects over time. In many cases, the trap may be designed merely for monitoring rather than elimination of pests.

The adhesive may be any sticky, tacky, or gummy material that traps an insect and prevents the insect from leaving. In many cases, the adhesive may have additives that attract insects in general, or it may have additives that may attract specific insects. The additives may attract insects by smell, taste, color, or any other mechanism.

Various features of the trap may be used for standardizing images of the trap. Some traps may have registration marks, such as crop marks, edges, points, or other mechanical or printed features that may assist in orienting and scaling images of the trap. Some traps may have features that may be used for color-correcting the images. Such features may include a known background color, color standards, and the like. Some traps may include standard color swatches such as red, blue, green, or cyan, magenta, yellow, and black, or other colors.

Classification and Trap Management System

A classification and trap management system may collect information about a monitoring trap, classify any insects in the trap, and manage data relating to the trap. A classification and trap management system may be used in several different scenarios, including pest professionals, landlords, homeowners, and various agricultural scenarios.

In general, a classification system may receive an image of a trap, apply some pre-processing of the image for standardization, and provide a classification and count of insects caught in the trap. The classification may include identification of the insect or item shown in the trap. Some classification systems may be fully automated, such as in the case of a machine-learning image analysis system, while other systems may be manual, where human experts identify the insects. Some systems may be a hybrid system, where automated image analysis may be performed first, with a human verifying or modifying the classification.

Automated classification systems may be particularly useful in cases where a user may wish to have immediate feedback. For example, a homeowner may notice insects in their house and may be particularly worried about them. Once a trap is placed and insects are caught, they may be anxious to know what the insects are, what dangers, if any, the insects pose, and how to handle the insects. With an automated classifier, such diagnosis may be available in seconds.

A trap management system may keep track of traps as they are installed. The trap management system may collect a succession of images over time, showing the progression of insects or lack thereof over a period of time. A trap management system may store records of installed traps and may send reminder notifications when updated images are requested.

In an example of a landlord/tenant scenario, a landlord may provide monitoring traps to a tenant and ask the tenant to take an image of the traps with their cell phone or other mobile device with a digital camera. The trap management system may send reminder messages to the tenant according to an update schedule. The tenant may take the images and transmit the images to the trap management system. When insects are identified, a system may alert both the landlord and tenant of the identification.

The trap management system may have different user interfaces for different users and different scenarios. A homeowner or tenant user interface may be, for example, a website where the history of their traps may be viewed and managed. A homeowner's view may show each of their installed traps, along with the insects identified and counted with each periodic image. As traps are retired and new traps installed, a history of the insects within their home may be available.

A landlord's view of a trap management system may show similar information as the homeowner interface, but it may add features that may be useful to a landlord or property manager. For example, a landlord view of an apartment complex may show a map of the units in the complex. Each unit may be shown with a color, such as green, yellow, and red. Red may indicate an outbreak has been detected in a unit, while yellow may indicate that the neighboring units have heightened monitoring. Green may indicate that no pests have been identified.

The landlord's trap management interface may allow the landlord to increase monitoring in various units, such as a unit adjacent to one with a known insect problem. For example, when one unit had bedbugs detected, the neighboring units may be increased to weekly or daily monitoring of their traps. The reminders may be sent out through the trap management system so that the landlord does not have to manually contact each neighboring tenant and ask for their cooperation. Such a system may allow a landlord or property manager to take quick action when an outbreak may be detected. Such quick action may prevent widespread outbreaks of insects such as bedbugs through a large apartment complex, which benefits tenants and reduces remediation costs for the landlord.

Pest professionals may have a set of user interfaces and workflow processes for managing their customers. Many pest professionals may offer a subscription service, where customers pay for pest control over a period of time, such as a year. When a customer discovers a pest, the customer may call the pest professional to complain. Rather than dispatching a truck and a pest control operator to the premises, the pest control professional may send a monitoring trap to the customer. The customer may install the trap, then send an image of the insect for classification. Such a system may dramatically reduce costs for the pest professional, while being responsive to the customer.

Many pest professionals may install traps in their customer's locations and ask the customer to periodically take images of the traps. The trap management system may manage the reminders, collect the images, perform the classification, and make the results available to the pest professional and, in some cases, to the customer as well. A typical use case may be for the pest professional to perform a service, such as fumigation or other pest eradication service, then install monitoring traps for the customer to periodically check.

The end user may use a mobile device app to receive reminders, capture and send images, and review current or historical information about their traps. In some cases, a website may be used. Such an app may be able to capture additional information relating to a customer and their trap, such as the Global Positioning System (GPS) coordinates of the trap, customer address, billing and payment information, and other information.

Some systems may operate through Short Message Service (SMS or “text”) on a mobile phone. A trap management system may send an SMS message to a user to remind them to take an image. The user may reply to the SMS message with an image of the trap, then the trap management system may reply with an SMS message with the classification of an insect identified in the trap. Such an exchange may be a simplified interface that may not use any app.

One distribution channel may be to sell monitoring traps directly to homeowners or customers, who may set out their traps. When an insect is caught, the customer may take an image of the trap. In some cases, the trap may include a barcode or other machine-readable information that may launch a webpage or otherwise assist in transmitting an image of the trap for analysis. A trap may be sold with a predefined number of permitted analyses. For example, a trap purchased from a retail store may be sold with three analyses included. In such cases, a customer may have an option to purchase additional analyses over time. Some such services may include a subscription option, where new traps may be sent to the customer every several months or whenever the traps become dirty or are otherwise used.

Throughout this specification, like reference numbers signify the same elements throughout the description of the figures.

In the specification and claims, references to “a processor” include multiple processors. In some cases, a process that may be performed by “a processor” may be actually performed by multiple processors on the same device or on different devices. For the purposes of this specification and claims, any reference to “a processor” shall include multiple processors, which may be on the same device or different devices, unless expressly specified otherwise.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

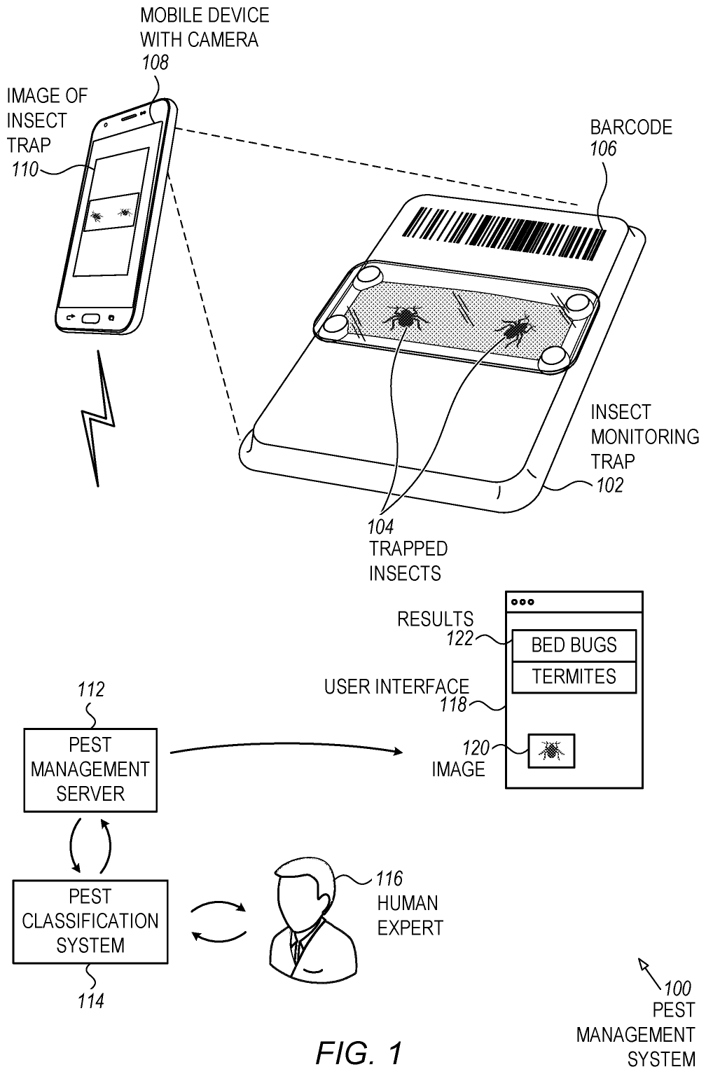

FIG. 1 is a diagram illustration showing an embodiment 100 of a pest management system. An insect monitoring trap 102 has several trapped insects 104, as well as a barcode 106. A user has a mobile device 108 with a camera, and takes an image 110 of the trap 102.

The image may be transmitted to a pest management server 112, which may send the image to a pest classification server 114. The pest classification server 114 may be an automated classification mechanism or may use a human expert 116 to perform the classification or to validate that the classification was correct.

The results of the classification may be made available in a user interface 118, which may include a copy of the image 120 of the trap, along with the results 122 of the classification.

The system of embodiment 100 may represent a simplified version of an insect identification and monitoring system. Such a system may be used by homeowners or consumers to monitor and identify pests in their home or residence. Such a system may also be used by pest professionals, landlords, building managers, property managers, farmers, horticulturalists, or anyone else who deals with, manages, or provides services related to insects or pests.

In a typical use case, a monitoring trap 102 may be placed in a home, residence, building, or area where there may be concerns about insects. In the case of a building manager for a hotel or short-term rental property, for example, traps may be placed and monitored over time to ensure that no infestation has occurred. When an infestation may be detected in one room, the affected room and neighboring rooms may be quickly treated to prevent further infestation.

A property manager for an apartment complex may place monitoring traps in all the units of the apartment complex. Each apartment may have a historical record of any pest presence. Such historical record may show a prospective tenant, for example, that an apartment is free of pests prior to them renting the apartment.

A homeowner may purchase a monitoring trap 102 from a retail store, and such a trap may include one or more automated pest detection analyses. When the homeowner sees an insect on the trap, the homeowner may take a digital picture of the trap, upload the trap to the pest management server 112, and receive an identification of the insect. In many cases, the consumer may be presented with steps to eradicate or manage the pest in their residence, or the consumer may be offered services from a pest professional.

A pest professional may use monitoring traps 102 with several of their customers. As part of regular monitoring, a pest professional may install traps 102 in a customer's location, and they may ask the customer to periodically take images of the traps. The images may be processed by the pest management server 112 and any indication of insects may be sent as alerts to the pest professional and the customer.

In an agricultural example, the monitoring traps 102 may be placed near crops to monitor the presence of beneficial and harmful insects. The traps may be monitored by a grower, who may take images of the traps and upload the traps to the pest management server 112. The grower may have a historical record of pest population, along with alerts when harmful insects have been detected.

The pest management server 112 may provide reminders to end users, customers, or consumers to take an image of a trap. When a reminder is received, the user may take an image using a conventional cellular phone or device with a digital camera then upload the image. The reminders may be sent on a regular schedule, although the schedule may be adjusted for various reasons. For example, a schedule may be relaxed during seasons when pests are not as prevalent, but a monitoring frequency may be increased during seasons when pests are expected. In another example, a schedule may be increased when pests have been detected nearby, such as in the same state or city, or when pests were detected in the same apartment complex or neighborhood.

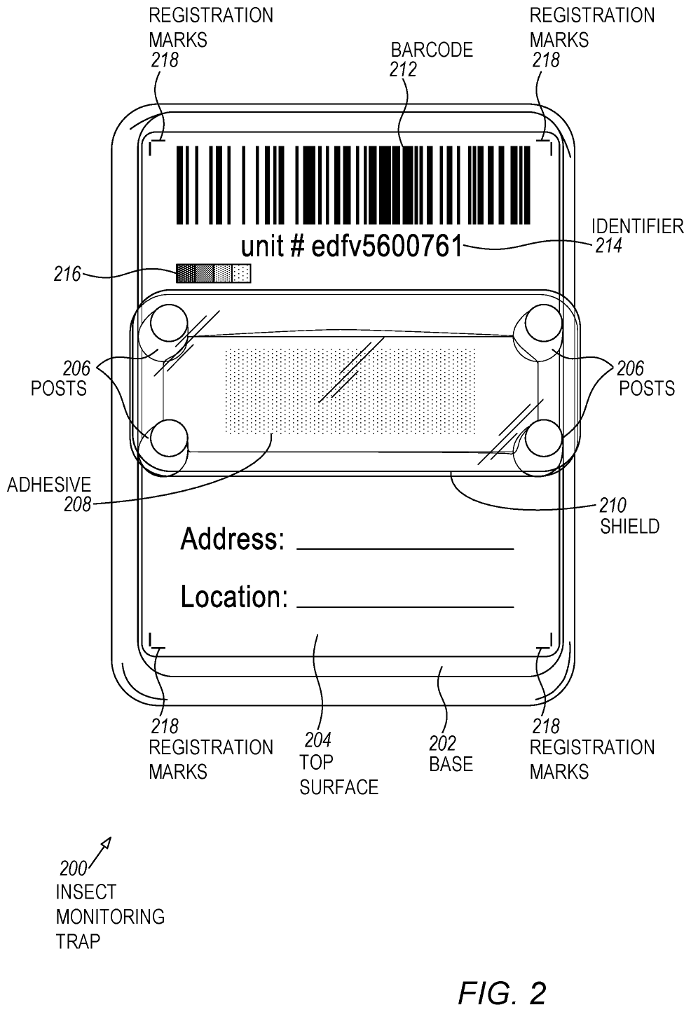

FIG. 2 is a diagram illustration of an embodiment 200 showing an insect monitoring trap. Embodiment 200 is merely one example of a monitoring trap that may be used with a pest management system. Embodiment 200 is an example of a monitoring trap that may be used indoors in a residence or other location.

A base 202 may have a top surface 204. The top surface 204 may have several elements that may be captured in a single image of the trap 200. Such features include an adhesive 208 where insects may be trapped, a barcode 212 and identifier 214, a color standard 216, and various registration marks 218.

The features captured in an image may assist in automatically identifying the trap as well as any insects found in the trap. A single image with these features may be processed to determine the unique identifier for the trap so that data associated with the trap may be stored in a database. Such data may include the physical location, user information, account information, and the detection and classification of any insects.

The optical features such as the color standard 216 and registration marks 218 may be used for color correction, intensity correction, orientation, cropping, scaling, and other adjustments to the image. Such adjustments may help make images consistent, which may increase the effectiveness of automated detection algorithms.

One element of color correction may be the background color of the base 202. For example, a trap may be constructed with a white colored base 202. The white color may be used as a reference for performing various image correction transformations.

The reference marks 218 may be printed or mechanical features of the base 202. In some systems, the external edges and corners of the base 202 may be detected in an image correction algorithm to resize or orient an image of the trap 200.

A shield 210 may be mounted over the adhesive 208. The shield 210 may be transparent such that an image of the underlying adhesive and any insects may be captured. In many cases, a gap of 0.125 to 0.500 inches may exist between the underside of the shield 210 and the top of the adhesive 208. In the example of embodiment 200, the shield 210 is mounted on four posts 206 which create the gap between the shield 210 and the adhesive 208.

The shield 210 may be useful in situations where a pet, youngster, or even a robot vacuum cleaner may be present. The shield 210 may prevent a pet, child, or vacuum from touching the adhesive and thereby coming in contact with the insect or adhesive. The adhesive may have insect-attracting qualities or may have insecticide-qualities.

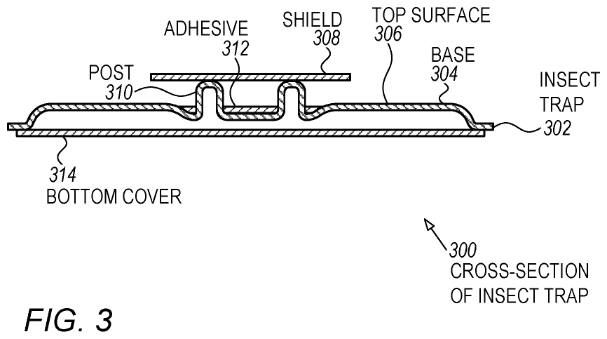

FIG. 3 is a diagram illustration of a cross-section view of an embodiment 300 showing a monitoring trap, similar to the monitoring trap of embodiment 200.

The monitoring trap 302 may be manufactured from a thermoformed plastic sheet for the base 304. The base 304 may have a top surface 306 which may have the adhesive 312 and various markings and identifiers.

A shield 308 may be mounted to various posts 310 and may prevent the adhesive 312 from being contacted. The shield 308 may be transparent such that an image of the trap 302 may include any insects that may have been trapped in the adhesive 312.

A bottom cover 314 may be a second plastic component or a label that may span the formed underside of the base 304. In many cases, the bottom cover 314 may include instructions for preparing and placing the trap 302. Such instructions may include a website or other communications instructions for transmitting an image of the trap 302 and receiving insect classifications.

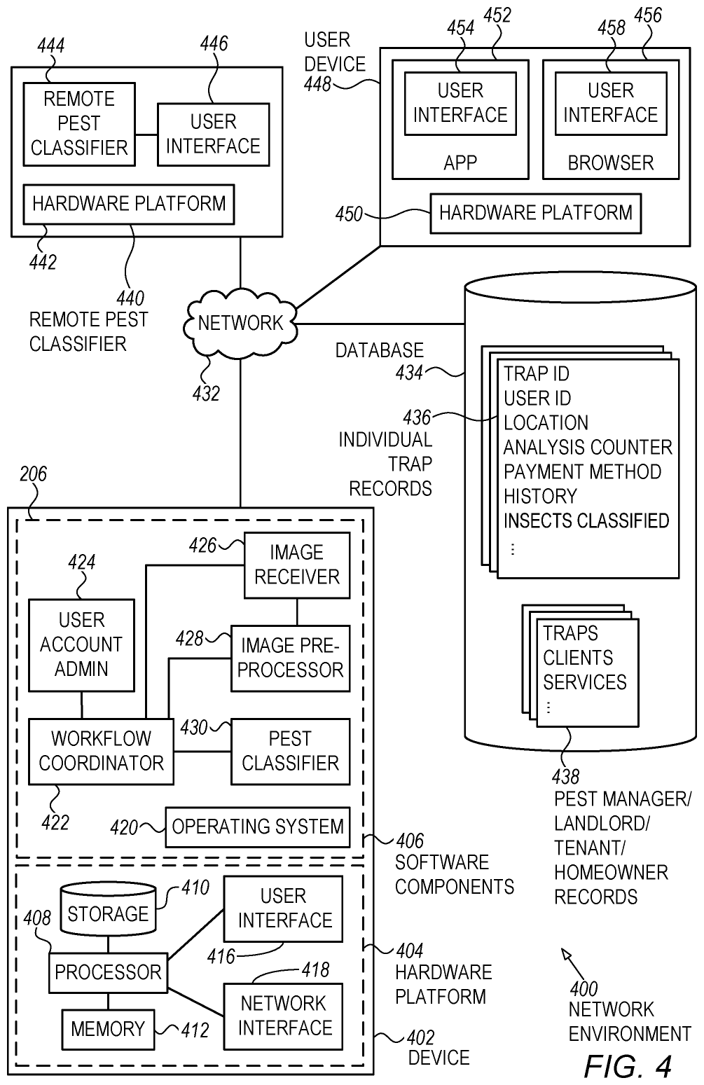

FIG. 4 is a diagram of an embodiment 400 showing components that may deploy and manage monitoring traps. Embodiment 400 is merely one example of an architecture that may manage monitoring traps in the field, arrange for classification of images of those traps, and provide other services relating to the insect traps.

The diagram of FIG. 4 illustrates functional components of a system. In some cases, the component may be a hardware component, a software component, or a combination of hardware and software. Some of the components may be application level software, while other components may be execution environment level components. In some cases, the connection of one component to another may be a close connection where two or more components are operating on a single hardware platform. In other cases, the connections may be made over network connections spanning long distances.

Each embodiment may use different hardware, software, and interconnection architectures to achieve the functions described.

Embodiment 400 illustrates a device 402 that may have a hardware platform 404 and various software components. The device 402 as illustrated represents a conventional computing device, although other embodiments may have different configurations, architectures, or components.

In many embodiments, the device 402 may be a server computer. In some embodiments, the device 402 may still also be a desktop computer, laptop computer, netbook computer, tablet or slate computer, wireless handset, cellular telephone, game console or any other type of computing device. In some embodiments, the device 402 may be implemented on a cluster of computing devices, which may be a group of physical or virtual machines.

The hardware platform 404 may include a processor 408, random access memory 410, and nonvolatile storage 412. The hardware platform 404 may also include a user interface 414 and network interface 416.

The random access memory 410 may be storage that contains data objects and executable code that can be quickly accessed by the processors 408. In many embodiments, the random access memory 410 may have a high-speed bus connecting the memory 410 to the processors 408.

The nonvolatile storage 412 may be storage that persists after the device 402 is shut down. The nonvolatile storage 412 may be any type of storage device, including hard disk, solid state memory devices, magnetic tape, optical storage, or other type of storage. The nonvolatile storage 412 may be read only or read/write capable. In some embodiments, the nonvolatile storage 412 may be cloud based, network storage, or other storage that may be accessed over a network connection.

The user interface 414 may be any type of hardware capable of displaying output and receiving input from a user. In many cases, the output display may be a graphical display monitor, although output devices may include lights and other visual output, audio output, kinetic actuator output, as well as other output devices. Conventional input devices may include keyboards and pointing devices such as a mouse, stylus, trackball, or other pointing device. Other input devices may include various sensors, including biometric input devices, audio and video input devices, and other sensors.

The network interface 416 may be any type of connection to another computer. In many embodiments, the network interface 416 may be a wired Ethernet connection. Other embodiments may include wired or wireless connections over various communication protocols.

The software components 406 may include an operating system 418 on which various software components and services may operate.

A workflow coordinator 422 may be an administrative service that may handle various workflows associated with insect monitoring traps. Examples of different workflows may be workflows associated with consumer-procured traps, pest professional-distributed traps, traps managed by property managers and landlords, and traps used in agricultural settings. Each type of user and use scenario may have one or more workflows that may be triggered during the lifecycle of the user and the lifecycle of a trap.

A user account administrative portal 424 may manage user accounts, payment settings, and other options.

For example, a consumer product may be sold with a “free” pest analysis of any insect caught in their trap. A consumer offering may allow the consumer to send in an image and receive an analysis. The consumer may be offered free or paid subscription that may include reminders for future events to check the trap, a historical log of their traps and observations, helpful articles on pest remediation, and other features.

In another example, a pest professional may establish an account for their business, then may establish accounts for each of their customers. The customers may be able to log in and see their results, schedule checkups or service, and perform other functions. Similarly, a property manager may establish an administrative account for themselves and accounts for each of their tenants.

An image receiver 426 may receive images for a trap. The image receiver 426 may makes sure the trap has a valid ID number and that the account is up to date and authorized for image analysis. In cases where the trap has not been seen before, the image receiver 426 may create a database record for the trap and associate the record with a customer account. If no such customer account is present, one may be created.

A preprocessor 428 may analyze the quality of the image and perform various transformations to standardize the image for analysis. For example, a preprocessing step may attempt to adjust the lightness of the image to a standard. If the image is not capable of being transformed appropriately, or if the amount of variance from a standard is too much, the image preprocessor 428 may send a message to the person who took the image. The message may identify the problem, such as being too dark, too over exposed, too slanted, too far away, too close, etc., and may request the person to re-take the image.

A pest classifier 430 may analyze the image to identify and count insects stuck in the trap. The pest classifier 430 may be an automated image recognition and classification algorithm. In some cases, the pest classifier 430 may have a user interface through which a human may perform the classification.

A remote pest classifier 440 may be available through the network 432. The remote pest classifier 440 is illustrated as a separate system on a separate hardware platform 442, although the functions and features may also be incorporated into the device 402.

A remote pest classifier 444 may be an algorithm or application that may identify and classify insects in an image of a trap. In some cases, a user interface 446 may allow a human expert to perform the classifications, monitor classifications, or to handle classifications that the remote pest classifier 444 may have identified with poor confidence.

A database 434 may capture and store data associated with traps and customer accounts. The example of database 434 is a simplified example of the types of information that may be stored and used by the various devices and services of embodiment 400. Individual trap records 436 may include the trap ID, the user ID associated with the trap, the trap location, an analysis counter, payment methods, history of the trap, the insects classified on that trap, and other information.

The analysis counter may be a variable that permits a user to have their trap's image analyzed. Some business scenarios may allow a user to have a small number of analyses of their trap, such as one, two, or three analyses. If a user wishes to have more analyses, they may be offered to purchase additional analyses.

Account records 438 may be set up for different types of users. Different types of accounts may exist for homeowners, landlords, pest professionals, farmers, or other classes of users. In some cases, such as landlords or pest professionals, sub-accounts may be created for their clients. These account records may identify the services that may be available under that type of account.

A user device 448 may be any device used by a user. A user may be the end user, tenant, homeowner, or installer of a monitoring trap. A user may also be a building manager, pest professional, or other person who may manage multiple customers and many traps. Their hardware platform 450 may include a digital camera, and their interface may be through an app 452 with a user interface 454. In some instances, a user interface 458 may be through a browser 456.

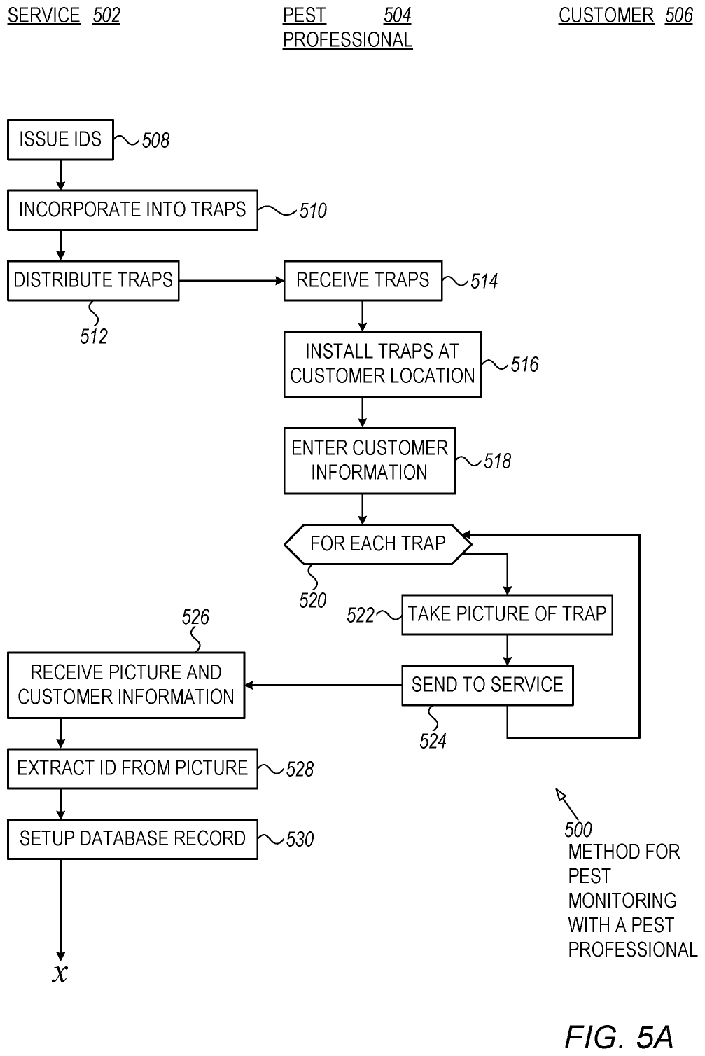

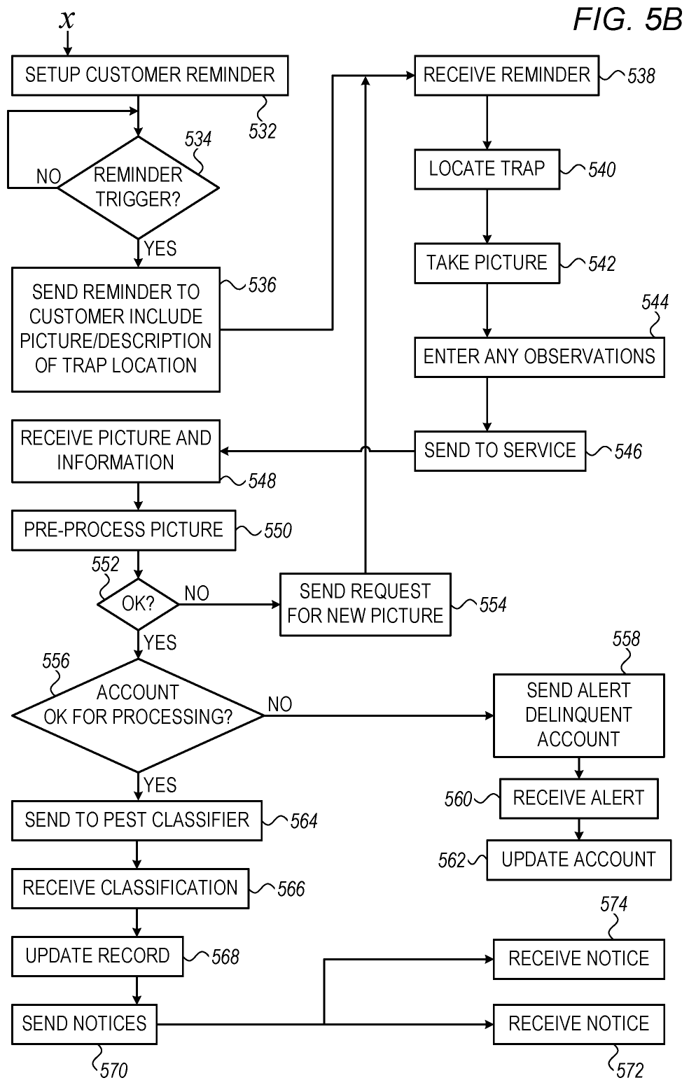

FIGS. 5A and 5B are flowchart illustrations of an embodiment 500 showing a sequence of exchanges between a pest monitoring service 502, a pest professional 504, and a customer 506. The operations of the service 502 are illustrated in the left hand column, the operations of the pest professional 504 are illustrated in the center column, and the operations of a customer 506 are illustrated in the right hand column.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

The sequence of embodiment 500 are merely one example of a scenario showing monitoring traps may be deployed with a pest professional. In this example, the pest professional may install the traps in a customer's home, and the customer may periodically take images of the traps using their device, typically a cellular telephone. The service may manage the trap information and may perform classification of the image.

The service 502 may be a business that manufactures and distributes monitoring traps, as well as provide computer-based services for capturing, managing, analyzing, and distributing data about the traps.

The pest professional 504 may be a business that provides pest management and eradication services. In a typical scenario, a customer 506 may subscribe to a pest professional's service contract to monitor and eradicate pests in the customer's premises. Sometimes, a contract may be for a single treatment or set of treatments, while in other cases, a contract may be for ongoing treatment and maintenance treatments over a period of time.

In these types of scenarios, a pest professional 504 may install monitoring traps that the customer 506 may monitor. Having an on-site monitoring trap may help the pest professional from having to roll a truck and send a service technician to the premises unnecessarily. When a customer detects a pest, the customer 506 may use the trap to communicate the presence of the pest, rather than merely calling when a pest is observed crawling across the floor, for example. In the latter case, a pest professional may arrive at the premises to not find the pest and waste the visit. Because the image of the pest on the trap can be identified and classified, the pest professional will know that pests are actually present, which pests are present, and how to deal with the pests prior to arriving at the customer's premises.

A service 502 may issue IDs in block 508 which may be incorporated into traps in block 510. The IDs may be unique identifiers for each trap. Information associated with the traps may be stored in a computer database, and later associated with information defining where and when the traps were placed, any analyses of the traps, and a historical record of the traps over time.

The service 502 may distribute traps in block 512 to the pest professional 504, which may receive the traps in block 514.

The pest professional 504 may install traps at the customer location in block 516. The installation may involve physically placing the traps at locations around the customer's premises by a service technician. The customer's information may be entered in block 518 and, for each trap in block 520, a picture of the trap may be taken in block 522 and sent to the service in block 524.

The process of blocks 518 through 524 may identify which traps may be associated with the specific customer 506. In a typical residential, commercial, or industrial use case, the number of traps may vary from single digit numbers to tens or even hundreds of traps in larger installations.

The customer information collected in block 518 may include the customer's preferred and alternate mechanisms for communication. The service 502 may be capable of communicating with the customer 506 through email, SMS text messaging, alerts on an app, or other mechanism. Some systems may send reminders or alerts through SMS text messaging, for example, while more detailed information through email or an app. Some systems may use a custom app that may be downloaded and installed on a customer device. A custom app may allow the user to establish communications with the service 502 and the pest professional 504, as well as manage their contracts, make payments, view history of their accounts and individual traps, receive recommendations, and other functions.

When each trap may be installed, a record of the trap location may be captured. For example, a trap may be recorded as “behind water heater” in a text variable. In some cases, the installing party may take a wide-angle view of the trap in the location. In the example of a trap near the water heater, an installer may take a picture showing the water heater and the trap on the floor next to the water heater. This picture may help the customer 506 locate the trap when the customer may be asked to update the status of the trap.

A picture of the trap may be taken in block 522. The picture of block 522 may be a full-frame image of the trap itself. Such a picture may include the computer-readable identification number assigned in block 510. The picture may serve several uses. First, the machine-readable identification may be extracted from the picture and used to correlate the customer information with the trap. Second, the picture of the trap in its pristine condition when installed may establish a timeline and baseline condition for the trap.

In many instances with pests, there may be some confusion about when pests were present. A homeowner may witness pests and contract with a pest professional to eradicate the pests. The pest professional would like to have documented evidence of the success of their treatment, which the monitoring traps may provide with a documented timeline. In a similar use case for a landlord, both a tenant and landlord may want verification that a unit is pest-free before moving in. The tenant may want the verification to feel comfortable with the property. The landlord may want the verification so that the tenant cannot blame the property manager or landlord when pests arrive later.

The pictures and information about the traps may be received by the service 502 in block 526. The trap identification may be extracted from the picture in block 528 and used to create or modify a database record in block 530. The database record may include information about the pest professional, customer, trap location, and other information.

In many instances, a pest professional 504 may establish an account with the service 502. The account may include the pest professional's business information, contract with the service 502, method of payment, feature set, and other information. Within the pest professional's account, individual accounts for each customer 506 may be established.

The pest professional may be able to create and manage customer accounts from an administrative interface. The administrative interface may consolidate several customer's accounts into a single view. Such a view may allow a pest professional to see all their customers and identify any open issues with the customers.

Many scenarios may establish customer accounts for each customer. Within this portal, a customer may be able to view the traps associated with their account, a history of each of the traps, any pests identified on the traps, as well as services performed by the pest professional. In some cases, the customer account may allow the customer to communicate with the pest professional, such as send messages or queries, schedule service appointments, upgrade or downgrade their contracts, make payments, and other services. In some cases, the customer account may be branded with the pest professional's logo, contact information, and other information.

In block 532, a customer reminder may be set up. A loop at block 534 may cycle until a trigger for a customer reminder executes, in which case, a reminder may be sent in block 536.

A customer reminder may request that a customer visit the monitoring trap and take an image of the trap. The image may be used to document the time and place of the trap, as well as identify and record any pests caught in the trap.

The customer reminder may include information about the trap to aid the customer to locate the trap. For example, a residence may have 5 traps installed. For each trap, a reminder may be sent that requests a picture of a trap with its location. In the example of a trap near a water heater, the reminder may have a location field of “near water heater.” When a wide-angle view of the location was taken initially, this image may be transmitted to the customer to help them find the trap.

The customer 506 may receive the reminder in block 538, locate the trap in block 540, take a picture of the trap in block 542, enter any observations in block 544, and send the picture to the service in block 546.

In many cases, the customer 506 may only take a picture of the trap and hit “send” on their app or device with very little extra actions. In one use case, a reminder may be sent to the customer 506 using an SMS text message. In the use case, the customer 506 may locate the trap using the information in the SMS text message, then snap a picture of the trap and hit “send” on their SMS messaging app. Such a user experience may have a minimal amount of friction for the customer 506 and operate with little or no installation of additional software on their device.

In another case, a custom app may be downloaded and installed on a customer's device. In such a case, an alert may be sent to the customer through the app, SMS text messaging, email, phone, or other channel. The customer may open the app, then use the app to take a picture and upload to the service.

The customer 506 may have the opportunity to add observations in block 544. The observations may be an open-ended text field where the customer adds free-form notes, questions, or other information. In some cases, a customer may be presented with one or more questions to answer. For example, a submission may be followed by a short question, such as: “did you see any insects on the trap?” or “is the trap dirty and should be replaced?” or other questions. In some systems, the customer's response to a question may lead to additional questions to gather information. Such information may be stored in an electronic database associated with the individual traps as well as the customer's account.

The customer's additional information may be used by the service 502 or pest professional 504 to augment or change the workflow. For example, some systems may not perform a pest identification process unless the customer positively indicates that insects were present on the trap.

The picture and information from the customer 506 may be received by the service 502 in block 548. The picture may be pre-processed in block 550 to determine whether the image is appropriate for further processing. If the image is not OK in block 552, a request may be made in block 554 to take a different picture. In many cases, the request in block 554 may indicate any issues with the original picture, such as if the image was too close, too far away, too slanted, too dark, too bright, or other issues.

In block 556, an analysis may be made to determine whether the account is OK for further processing. In many cases, the service 502 may charge money for the services, including identifying pests. One version of such a service may charge per pest identified, while other versions may allow unlimited numbers of classification or identification processes to be executed during a subscription period.

If the account is delinquent or has other issues in block 556, an alert may be generated in block 558 and transmitted to the pest professional 506. The pest professional 506 may receive the alert in block 560 and may update their account in block 562.

If the account is OK for further processing in block 556, the image may be sent to a pest classifier in block 564 and the results may be received in block 566. The electronic database records may be updated in block 568, and notices may be sent in block 570 to the pest professional 504 and customer 506. The pest professional 504 may receive their notice in block 572 and the customer 506 may receive their alert in block 574.

The pest classifier may be an automated, semi-automated, or manual classification and counting of insects found in the monitoring trap. Some systems may have machine learning systems that automatically process an image to identify and count insects. Other systems may have human experts who may classify and count insects. Still other systems may use a combination of automated and human classification.

The term “classification” may involve any level of pest identification and feedback about insects in a trap. In some cases, the classification may include genus and species of an insect, while in other cases, the classification may use common insect names. The classification may include information about the level of danger or hazard an insect may pose to an occupant, such as the disease-carrying capability of the insect. The classification may, in some cases, include common causes of infestations and recommended remedial action that can be taken.

The notices sent to the pest professional 504 and customer 506 may contain different types of information or may be presented in different ways for each recipient. For example, a notification to the customer 506 may include the pest classification and other general information for the pest found in the trap, as well as suggestions that the customer can do to minimize the pests. The notification to the pest professional 504 may include the pest classification and may identify the severity of the issue. The severity rating may help the pest professional 504 respond quickly to insect outbreaks that have a high probability of rapidly spreading, for example, or react more slowly to other issues.

The sequence of embodiment 500 may illustrate one scenario where a monitoring trap and service 502 may be used. Other use cases include landlord/tenant scenarios, homeowner scenarios, horticulture scenarios, and the like. Each scenario may have different nuances for how and why trap placement and management may be deployed, as well as various differences on functional features.

For example, a landlord or property manager may require their tenants to keep monitoring traps in their rented units, and the tenants may be required to periodically take images of the traps. Such a use case may help the property manager ensure that the rental units were well cared for, but also identify and treat outbreaks early. In many cases, outbreaks may be traced back to a specific tenant that caused a pest outbreak.

In another use case, a landlord or property manager may keep and monitor traps in vacant units. This may assure potential tenants that the units are insect-free when they move in, but also provide evidence that insects may have been caused by the tenant, not a pre-existing condition of the landlord.

In a homeowner scenario, the functions of the pest professional 504 and customer 506 may be merged. A homeowner may receive traps, install the traps, and set up a reminder schedule with the service 502. When the homeowner takes pictures of the traps, the notices may be sent to the homeowner. In such a scenario, the homeowner may be provided with a website, portal, or app where they can establish an account, create reminders, view historical sequences of their traps, order replacement traps, or perform other functions.

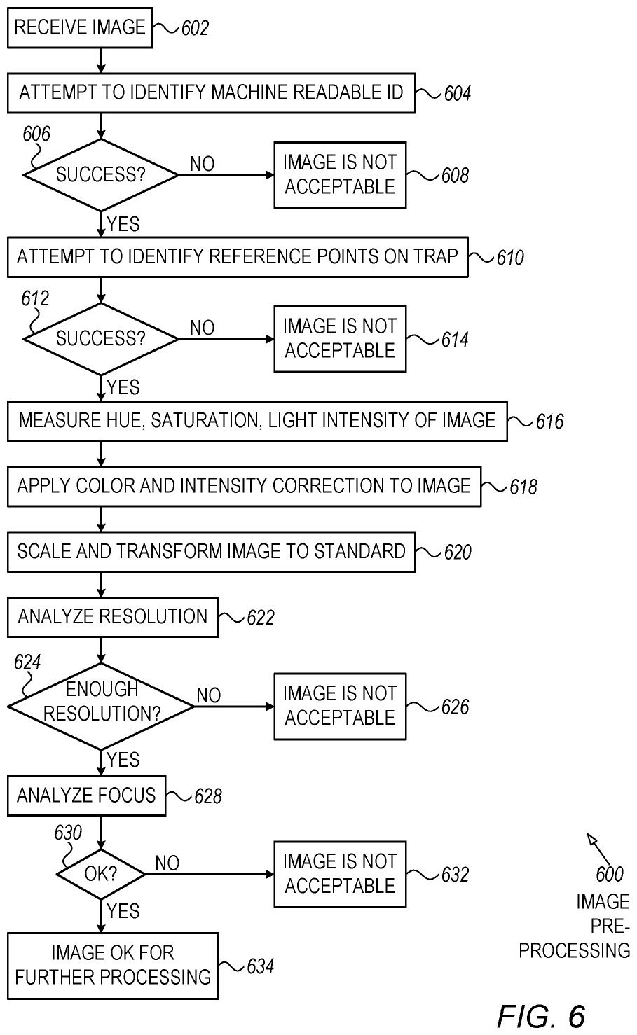

FIG. 6 is a flowchart illustration of an embodiment 600 showing a sequence for image pre-processing. The pre-processing sequence may analyze an incoming image of a monitoring trap and determine if the image is acceptable for processing. In many cases, the image may be transformed or modified so that the image may be more easily processed by automated image analysis systems.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 600 may illustrate one sequence by which images taken by end users or customers may be analyzed. The typical customer may be a lay person with no pest control training, and they may not appreciate or understand the way images may be processed.

In general, a “good” image of a trap may be one where the machine-readable identification may be extracted and read, where the scaling and pixel density is sufficient to get a good analysis, and where the lighting intensity and color can be adjusted to render consistent images.

An image may be received in block 602. An attempt may be made in block 604 to extract and read the machine-readable identification. If the machine-readable identification is not successfully read in block 606, the image may be labeled not acceptable in block 608.

An attempt may be made in block 610 to identify reference points on the trap. The reference points may be targets printed or molded into the trap or may be features of the trap that may be used as reference points. For example, the edges of a trap may be used as reference points or reference indicators. When the reference points or reference indicators are identified in the image, further processing of scaling and orienting the image for analysis may be performed.

If the reference points are not identified in block 612, the image is not acceptable in block 614.

The hue, saturation, light intensity, and other image parameters may be measured in block 616. The parameters may be used in block 618 to apply color and intensity correction to the image. The image may be scaled and transformed in block 620 to match a standard orientation and cropping.

The resulting resolution of the image may be analyzed in block 622. If the resolution is less than a predefined minimum resolution in block 624, the image is classified as not acceptable in block 626.

Similarly, the focus of image may be analyzed in block 628. If the image is out of focus in block 630, the image is tagged as not acceptable in block 632. If the image passes the analysis of embodiment 600, the image is OK for further processing in block 634.

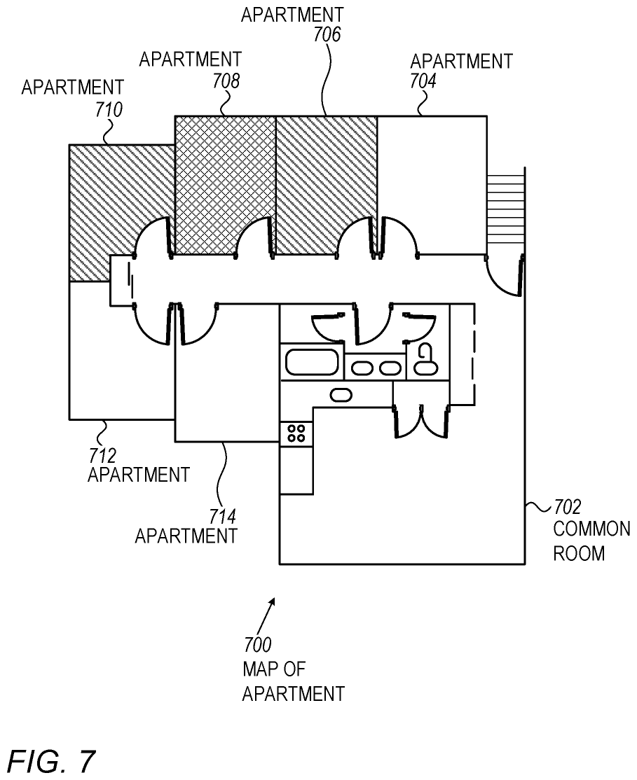

FIG. 7 is a diagram illustration of an example embodiment 700 showing a map of apartments. The map may include a common room 702 and apartments 704, 706, 708, 710, 712, and 714.

A scenario may occur where one of the apartments has a trap that catches a pest, such as a bedbug. In the example, apartment 708 may have a trap showing a bedbug. A user display may include a map of the apartments similar to embodiment 700, where the apartment 708 may be highlighted, such as displaying the apartment in red color.

When an insect is detected in one of the apartments, a landlord or property manager may be alerted. The landlord may be able to identify neighboring apartments and may cause the update frequency to be increased in the neighboring apartments. In our example, the landlord may receive a notice about bedbugs in apartment 708, and they may increase the frequency of monitoring in apartments 706 and 710. In a computer user interface, a map of the apartments may be displayed with apartment 708 in red, indicating a positive detection, and apartments 706 and 710 in yellow, indicating an increased monitoring frequency.

The example of embodiment 700 may illustrate one user interface through which a landlord or property manager may manage results from pest identification from a monitoring trap. Traps that return positive results may be highlighted, and the property manager may be able to change the monitoring frequency for other units nearby to ensure that an outbreak may be contained.

In the example, neighboring apartments on the same floor may be highlighted. In practice, a property manager may also identify apartments on floors above and below the infected apartments, as well as other apartments that may share a common area, may be located on the same wing or floor, or other criteria.

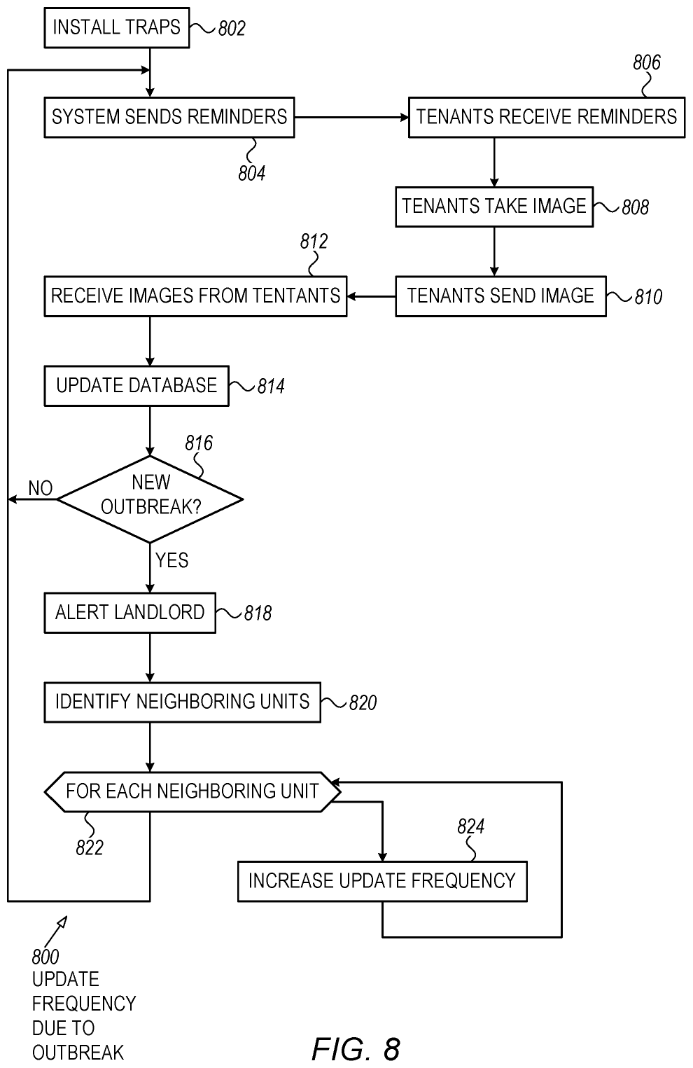

FIG. 8 is a flowchart illustration of an embodiment 800 showing a sequence where monitoring frequency may be changed due to a detection of insects. In the scenario illustrated in embodiment 700, a property manager or landlord may receive notice of pests in one of their units, then may change the monitoring frequency for other units in an attempt to minimize an outbreak.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 800 is one example of a sequence where monitoring frequency may be changed due to detection of insects. The monitoring frequency may change, for example, from monthly to weekly or even daily, depending on the situation.

After traps are installed in block 802, a regular cadence of sending reminders for trap updates may begin in block 804. The cadence may be weekly, bi-weekly, monthly, or some other cadence. A tenant may receive a reminder in block 806, take an image of their trap or traps in block 808, and send the images to a monitoring system in block 810.

The monitoring system may receive the images in block 812 and process the images to identify any pests. The electronic database may be updated in block 814.

If no new outbreak is detected in block 816, the process may return to block 804 to continue monitoring on the previous reminder cadence.

If an outbreak is detected in block 816, the landlord or property manager may be alerted in block 818. The landlord or property manager may identify neighboring units nearby a unit with an outbreak in block 820. For each neighboring unit in block 822, the update frequency for traps in those units may be changed in block 824. The process may continue to block 804 for reminders according to the updated cadence for those affected units and neighboring units.

The identification of neighboring units in block 820 may be a manual process. In such a process, a human may individually select traps or customers where an outbreak may be more likely, and therefore the person may increase frequency of data collection.

Some systems may perform automated identification of neighboring units. Such systems may have a database that may contain relationships between units, and a processor may identify neighboring units for increased monitoring based on one of the units having a positive detection.

Embodiment 800 is one example of how the reminder frequency may be changed in light of information about an outbreak. An increase in the reminder frequency may cause images to be collected on a more frequent basis, so that changes in

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

1. An insect trap comprising:
a base having a top side and a bottom side;
said top side having an adhesive portion, said adhesive portion comprising adhesive adapted to trap insects;
a shield mounted to said top side over at least a portion of said adhesive portion, said shield and said top side being configured such that a gap exists between said shield and said adhesive portion, said shield and said top side being further configured to form at least one opening allowing an insect to enter said adhesive portion;
said top side having a machine readable identifier;
said top side having a color reference comprising at least one pre-defined color.

2. The insect trap of claim 1, further comprising:
a removable sealing label over said at least one opening, said removable sealing label being configured to be removed to expose said at least one opening.

3-10. (canceled)

11. A method performed by at least one computer processor, said method comprising:
storing, by said at least one computer processor, an identifier for a first insect trap in an electronic database as a first record, said first insect trap having a machine-readable version of said identifier on a first side, said first side further comprising an insect capture mechanism;
receiving, by said at least one computer processor, an image comprising said first insect trap, said image comprising said machine-readable version of said identifier and at least a portion of said insect capture mechanism;
determining, by said at least one computer processor, that said machine-readable identifier corresponds with said first insect trap;
transmitting at least a portion of said image to a pest classification mechanism and receiving a pest classification from said pest classification mechanism;
storing said classification in said first record; and
presenting at least a portion of said first record available to a first user on a first user interface, said portion comprising said classification.

12. The method of claim 11, said insect capture mechanism comprising an adhesive pad.

13. The method of claim 11, said pest classification mechanism being a fully automated pest classification mechanism.

14. The method of claim 11, said pest classification mechanism being at least partially manual.

15. The method of claim 11 further comprising:
said first record having a pest analysis counter representing a number of permitted analyses for said first insect trap;
said storing said classification in said first record comprising changing said pest analysis counter.

16. The method of claim 15 further comprising:
when said pest analysis counter indicates that no analyses are available, not executing said pest classification mechanism.

17. The method of claim 16 further comprising:
when said pest analysis counter indicates that no analyses are available, transmitting a message to said first user.

18. The method of claim 17, said storing an identifier being performed after said receiving said image.

19. The method of claim 17 further said making at least a portion of said first record available being performed through a Universal Resource Identifier.

20. The method of claim 15 further comprising:
receiving a payment from said first user prior to said making at least a portion of said first record available to said user.

21. The method of claim 15 further comprising:
said first insect trap having a sale price comprising a setting of said pest analysis counter comprising at least one of said permitted analyses.

22. The method of claim 15 further comprising:
determining that said first insect trap is to be replaced and causing a second insect trap to be installed.

23. The method of claim 22, said causing said second trap to be installed comprising shipping said second trap to said first user.

24. The method of claim 22, said causing said second trap to be installed comprising sending a message to said first user to replace said first trap with said second trap, said second trap having a second identifier.

25. The method of claim 24 further comprising associating said second identifier with said first record.

26-29. (canceled)

29. A method comprising:
receiving an image comprising an adhesive area of an insect monitoring trap, said image comprising a machine-readable identifier;
analyzing said image to determine whether said image is appropriate for analysis;
when said image is not appropriate for analysis, transmitting a message requesting a second image;
when said image is appropriate for analysis, analyzing said adhesive area of said insect monitoring trap to determine whether pests are present;
when said pests are present, counting said pests to determine a number of said pests, and determining a classification of at least one of said pests; and
transmitting a classification message comprising said classification.

30. The method of claim 29, said analyzing said image to determine whether said image is appropriate for analysis comprising:
determining whether said image comprises an active area of said insect monitoring trap, said active area comprising at least a portion of said adhesive area;
when said image does not comprise said active area, determining that said image is not appropriate for said analysis;
when said image does comprise said active area, determining whether an image resolution within said active area is higher than a predefined minimum image resolution for said active area;
when said image resolution is less than said predefined minimum image resolution, determining that said image is not appropriate for said analysis;
when said image resolution is higher than said predefined minimum image resolution, determining that said image is appropriate for said analysis.

31. The method of claim 30, said determining a classification comprising:
transmitting at least a portion of said image to a human classifier and receiving said classification from said human classifier.

32-33. (canceled)
